(19) United States
(12) Patent Application Publication
(10) Pub. No.: US 2025/0139924 A1
(43) Pub. Date: May 1, 2025

(54) Systems and Methods for Interaction with Virtual Objects and Scenery

(71) Applicant: d3Labs Inc., Moultonborough, NH (US)

(72) Inventors: Barry Spencer, Moultonborough, NH (US); Julian George Spencer, Moultonborough, NH (US); Jeremy Egenberger, Pioneertown, CA (US)

(21) Appl. No.: 18/927,233

(22) Filed: Oct. 25, 2024

Related U.S. Application Data
(60) Provisional application No. 63/594,379, filed on Oct. 30, 2023.

(51) Int. Cl. G06T 19/20; G06F 3/01

(52) U.S. Cl. CPC G06T 19/20; G06F 3/012; G06F 3/013; G06T 2219/2004; G06T 2219/2016

(57) ABSTRACT

Exemplary embodiments include a system and method for user interaction with virtual scenes, the method comprising receiving, point cloud data for a physical space, including a position of the user in the physical space; extrapolating, from the point cloud data, the user's head position, hip position, and hand position; determining, from the head position and hand position, the user's height; establishing an eye to mouse vector directed through an eye position of the user to the screen, a neutral hip to hand vector, a neutral hip to screen vector, a mouse to cursor vector, and a mouse to virtual object vector; guiding a mouse on the screen of the display device by the eye to mouse vector, the neutral hip to hand vector, and the neutral hip to mouse vector; and guiding the mouse in virtual space by the mouse to cursor vector and the mouse to object vector.

### CROSS-REFERENCE TO RELATED APPLICATIONS

The present application claims the priority benefit of U.S. Provisional Patent Application 63/594,379, filed Oct. 30, 2023, and titled “Systems and Methods for Interaction with Virtual Objects and Scenery”. The present application is related to U.S. patent application Ser. No. 18/740,320, filed on Jun. 11, 2024 and titled “Display of Changing Three-Dimensional Perspectives Based on Position of Target Objects”, which is a Continuation and claims the priority benefit of U.S. patent application Ser. No. 18/478,795, filed on Sep. 29, 2023, titled “Display of Three-Dimensional Scenes with Changing Perspectives”, which claims the priority benefit of U.S. Provisional patent application Ser. No. 63/412,798, filed on Oct. 3, 2022, titled “Display of Three-Dimensional Scenes with Changing Perspectives”. These applications are hereby incorporated by reference in their entirety, including all appendices.

### FIELD OF INVENTION

The present technology pertains to systems and methods for sensing, analyzing, and computing user positions and actions and generating and displaying three-dimensional scenes that accordingly change, react to, and interact with a user. In particular, but not by way of limitation, the present technology provides for interaction with virtual objects and virtual scenes, including navigation through a virtual scene.

### SUMMARY

In some embodiments the present technology is directed to systems and methods for user interaction with virtual scenes comprising: one or more sensory input devices; at least one processor communicatively coupled to the one or more sensory input devices; and at least one memory communicatively coupled to the at least one processor, the at least one memory storing one or more instructions for executing the method by the at least one processor, the method comprising: receiving, by one or more sensory devices, point cloud data for a physical space, the point cloud data including a position of the user in the physical space; extrapolating, from the point cloud data, a position of a head of the user, at least one neutral hip of the user, and at least one hand of the user; determining, from the head position and hand position of the user, a height of the user; establishing an eye to mouse vector directed through an eye position of the user to the screen, a neutral hip to hand vector, a neutral hip to screen vector, a mouse to cursor vector, and a mouse to virtual object vector; guiding a mouse position on the screen of the display device by the eye to mouse vector, the neutral hip to hand vector, and the neutral hip to mouse vectors; and guiding the mouse position in the virtual space by the mouse to cursor vector and the mouse to object vector. Further embodiments include a non-transitory computer-readable storage medium having embodied thereon instructions which, when executed by a processor, perform the steps of the methods for user interaction with virtual scenes described herein.

### BRIEF DESCRIPTION OF THE DRAWINGS

In the description, for purposes of explanation and not limitation, specific details are set forth, such as particular embodiments, procedures, techniques, etc. to provide a thorough understanding of the present technology. However, it will be apparent to one skilled in the art that the present technology may be practiced in other embodiments that depart from these specific details.

The accompanying drawings, where like reference numerals refer to identical or functionally similar elements throughout the separate views, together with the detailed description below, are incorporated in and form part of the specification, and serve to further illustrate embodiments of concepts that include the claimed disclosure and explain various principles and advantages of those embodiments.

The systems and methods disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 diagrammatically illustrates an exemplary system and method for establishing, setting, and utilizing a three-dimensional coordinate space for object and scene interaction.

FIG. 2 diagrammatically illustrates an overview of four input modes for object and scene interaction.

FIG. 3 diagrammatically illustrates an exemplary Depth Sensor Mode.

FIG. 4 diagrammatically illustrates an exemplary embodiment of a reach vector.

FIG. 5 diagrammatically illustrates an exemplary Handheld Mode.

FIG. 6 diagrammatically illustrates an exemplary Hybrid Mode.

FIG. 7 diagrammatically illustrates an exemplary Peripheral Mode.

FIG. 8 diagrammatically illustrates an exemplary method for speed sensitive position stabilization.

FIG. 9 diagrammatically illustrates an exemplary method for virtual object and scene selection.

FIG. 10 diagrammatically illustrates an exemplary method for translation of objects in a virtual space.

FIG. 11 diagrammatically illustrates an exemplary method for rotation of objects in a virtual space.

FIG. 12 diagrammatically illustrates an exemplary navigation motion vector for navigating through one or more scenes in a virtual space.

FIG. 13 diagrammatically illustrates applications of a motion vector in a virtual space.

FIG. 14 further diagrammatically illustrates applications of the motion vector in a virtual space.

FIG. 15 diagrammatically illustrates an exemplary method of navigating a virtual scene using targeted movement.

FIG. 16 further diagrammatically illustrates an exemplary method of navigating a virtual scene using targeted movement.

FIG. 17 presents a diagram of an exemplary computing device.

### DETAILED DESCRIPTION

The approaches described in this section could be pursued but are not necessarily approaches that have previously been conceived or pursued. Therefore, unless otherwise indicated, it should not be assumed that any of the approaches described in this section qualify as prior art merely by virtue of their inclusion.

Visual display technology has continuously improved over time, allowing for mass production and consumption of very high-quality displays at relatively affordable prices. These high-quality displays have been integrated into every aspect of consumers' lives, whether at a miniaturized level with phones, tablets and laptops, or in larger sizes with monitor displays and television sets. However, one thing that has continuously been difficult to integrate into day-to-day display devices is a true three-dimensional viewing experience. While three-dimensional television sets have been produced, many utilize traditional stereoscopic technology which requires the use of special 3D glasses, making the experience inconvenient and less attractive to users. Moreover, traditional 3D viewing generally uses two streams of video images, one for the left eye, the other for the right eye. Both streams are rendered from a single fixed perspective.

Other solutions exist that integrate the idea of a three-dimensional viewing experience, the first being virtual reality (VR) technology, where the user wears a device such as a VR headset that immerses the user inside a three-dimensional world. However, wearing a headset is cumbersome and requires expensive equipment including very powerful hardware devices in addition to the headpiece, such as very powerful computing devices and graphical processing units (GPU). Furthermore, VR does not generally allow for the integration of the physical space inhabited by the wearer and his or her surroundings in the virtual world.

A second solution is Augmented Reality (AR) technology, which allows for the integration of a virtual image or video on top of physical space and the physical environment. However, AR simply places a virtual object, for example a virtual car—which may or may not be moving—on top of a physical environment, such as an empty parking space. Usually, the camera of a phone is used, and the car is displayed on the screen. Headsets may also be employed. However, AR technology generally does not respond to the user's position relative to virtual space or the display screen. For example, if the user moves laterally, but the phone he or she is using to display the virtual image remains pointed at the parking space, the objects displayed on the screen remain static. AR does not shift perspective of what is displayed based on where the user is looking or how the user's eyes or body are moving or oriented. Furthermore, AR is based on a relationship between a display screen or device and an environment.

What is presented in this document is a system where the relationship is between a user and his or her person and a virtual three-dimensional world.

The technologies presented herein are directed to systems and methods that provide a true three-dimensional viewing experience to interact with, and that react to a user's position, directionality, perspective, actions, and/or movement. The present technology integrates the virtual world rendered and displayed on a display device with the physical space inhabited by the user and other objects in their physical space. The systems and methods presented herein do not require a user to wear a headset, 3D glasses, carry a phone or other mobile device, have, or use any equipment on their person, although some embodiments feature use of gaming controls or smart devices. The technology also makes use of and display scenes on any ordinary display device including and not limited to television sets, a monitor, a phone, laptop, or tablet device.

The systems and methods presented herein may be further differentiated from current two- and three-dimensional viewing experiences in several ways. When displaying two-dimensional renderings of three-dimensional views, regardless of whether the view is a picture, video, game, drawings or otherwise, the renderings are displayed using ‘perspective data’ or information. This data includes, but is not limited to, the viewer's point in space relative to the content being viewed, the direction that the user is facing, and a field of view. In some embodiments, these are expressed as angles of width and height. In many embodiments, for media that is recorded and is being played to a user or observer, other factors are included in the perspective data or information, including but not limited to: any direction that one or more cameras are facing, the one or more cameras' field of view, the user's field of view on the display, and the one or more cameras' view of the user. The data is used to define the user's or observer's position, direction, and field of view.

In some embodiments, dynamically generated media, such as games, utilize a ‘virtual camera’ that defines the field of view for the viewer, or a first-person perspective that is changeable by the user themselves or the user's keyboard, mouse, controller, or other equipment. Examples of a virtual camera that react to a user's actions include a virtual car driving forward, with the virtual camera moving forward into the three-dimensional scene. Alternatively, a zoom feature can be used where the user may zoom in to a part of a rendered scene with a narrower field of view. In some embodiments, the user moves laterally to see behind virtual objects, or up or down to see over or under virtual objects. The user may also move closer to the screen to expand their field of view; or they may move laterally to duck behind a virtual wall.

In comparison to traditional two-dimensional and three-dimensional viewing experiences, either displaying recorded or dynamic media, and where additional 3D glasses may be necessary to generate the experience, the systems and methods presented herein present and display both two-dimensional and three-dimensional scenes of recorded or dynamically generated media. The viewing experience and perspective display updates and renders new three-dimensional perspectives based on changes to the user's position and other “perspective data” that can be collected. The user's position may take on an unlimited number of different perspectives, angles, and positions. Furthermore, the systems and methods herein do not require the use of 3D glasses, but some embodiments provide the option for their use if a user wants to enhance the depth of the viewing experience.

In various embodiments the systems and methods for interaction with virtual objects and scenery include one or more visual sensors, including but not limited to three-dimensional sensors, three-dimensional depth sensors or cameras, digital or web cameras, infrared cameras, and the like. The visual sensors are used to detect people, or other objects, movements, angles, directionality, or distance. Various embodiments also employ one or more display devices such as a monitor or television set. Other display devices may also be used including and not limited to mobile devices such as laptops, phones, or tablets. Various embodiments also utilize one or more computing devices to carry out underlying computations to run the methods described herein, including processing data, conducting computations and analysis, and rendering scenes to be displayed. Other devices may also be incorporated or be part of the systems and methods described herein, including input and output devices such as speakers and microphones.

In several embodiments the systems and methods described establish, set, and utilize a three-dimensional coordinate space and map the space on top of physical space. In preferred embodiments, the positive and negative coordinate space of both the x-axis and y-axis of this three-dimensional space are set to exist solely within the virtual world or virtual space. The virtual space exists on, and can be rendered on, a display device. In some embodiments, the z-axis is divided between the physical space occupied by a user or observer of the system and the virtual space rendered on the display device. The positive coordinates of the z-axis may occupy physical space, and the negative coordinates of the z-axis may occupy the virtual space within the display device, although alternative embodiments are envisioned where the positive and negative axes are reversed. It should further be noted that while preferred embodiments may use cartesian coordinates (x, y, z), alternative coordinate systems may be used as well, including left-handed and right-handed coordinate systems and cylindrical (r, θ, z) or spherical (r, θ, φ) coordinates.

In preferred embodiments, the point of origin (or 0 coordinate) of the z-axis is located on the surface of the screen of the display device, such that everything behind the screen is set along the negative coordinates of the z-axis and everything in front of the screen is in the physical world with the user and is along the positive z-axis coordinates. However, in several embodiments, virtual objects may also exist in the positive z-axis coordinates in physical space. For example, a virtual ball moving in the negative z-axis coordinates, existing solely within the display device, may bounce against a wall in the virtual space into the positive z-axis coordinates that exist in the physical space with the user, and may in turn bounce against a user or object back into the negative z-axis coordinates in the virtual space or virtual world. In various embodiments, this three-dimensional coordinate space is a 1:1 match with a user's coordinate system, allowing exact matching and 1:1 sizing between the virtual and physical worlds. For example, in embodiments using 1:1 sizing, a cup that is 70 millimeters high in the real world will appear to be 70 millimeters high in the virtual world. Such dimensional alignment helps the user envision objects in their true size and as they would appear if placed in the physical space.

In many embodiments, one or more sensor devices capture image data as point cloud data from the physical space occupied by a user. The different data points within the point cloud are then sorted based on their position on the z-axis, such as their coordinates on the z-axis determining their distance from the one or more sensor devices or one or more display devices. The image data is corrected, and noise and outliers are removed from the point cloud data set. After determining the different distances of the different remaining datapoints, any datapoints that are closely associated to each other are then used to build a model or shape of a certain volume. A foreground and background may also be determined. The models and shapes are further refined to produce more clearly defined shapes with set height and width characteristics.

Once these shapes are defined, they are then compared with pre-set or pre-defined parameters of “target objects”, and the shapes are then matched with the closest parameter or parameters. The shapes are then assigned the value of the closest parameter, which designates the object to equal the pre-set parameter and defines the shape as a specific target object. These target objects defined by the pre-set parameters either exemplify or characterize certain inanimate objects or body parts, as well as positions or configurations of these objects or body parts and provide certain value ranges into which objects or body parts may fall. For example, a pre-defined parameter may define a certain body part, such as the shape of a hand, nose, the structure of a face, eyes, or body parts in a certain position, a head turned sideways, a palm facing upwards, a palm facing the sensor, or one parameter for a left hand and another parameter for a right hand. Other parameters may be associated with inanimate objects such as a lamp, a table, or a chair.

In some embodiments, target objects identified by the system include a user's body. From point cloud data, the user's height and proportions are determined, and likely locations of the user's hands, fingers, and elbows are extrapolated. In some embodiments, the hand and elbow locations are determined using common proportions and ratios for human body measurements, such as arm length in comparison to overall height, forearm length in comparison to overall arm length, and head, shoulder, and waist position in comparison to overall height. From a determination of the location of the head, the eye position can be extrapolated as well. In other embodiments, the hand and elbow location are determined directly from the point cloud data. Some embodiments use a combination of these methods.

In some embodiments, once the user's hand, finger, and elbow positions are determined, the system uses the user position and original hand position to determine a range of positions in which the user's hand may move. The range includes, for example, a likely maximum side-to-side movement, a likely maximum forward-to-backward movement, and a likely maximum up-and-down movement. Using these probabilistic maxima, the system defines a zone in which the user's hand is most likely to be positioned at a given time.

In many embodiments, once objects are found that match the pre-set parameters, other objects that are not target objects are then removed from the dataset. The only remaining objects that the system earmarks are other target objects which are used by the system to further compute the user's position, viewing angle, perspective or direction, or their actions, or that are otherwise important.

In some embodiments, the one or more sensor devices sense the position and strength of actual lights in the user's room. Such embodiments allow the system to adjust the display based on the strength of the lighting in the physical space. Physical light sources in the room project onto the physical space scene to provide perspective-relative shadows. Alternatively, a user may opt to alter the lighting in the virtual space using a control device, vocal command, or gesture-based command, such as reaching for a light source in the virtual space. Applications using 3D sound technology may further enable the system to place virtual sound sources where they would be expected in the virtual scene.

In some embodiments, a user's hands interact with virtual objects. In these embodiments, temporal filtering or averaging may be employed to provide higher precision for identifying a hand, such as distinguishing between left or right hand and the gestures the hand is making. Furthermore, in some embodiments, a position of a first object is determined by evaluating its position relative to a second object. For example, the position of a hand is determined by calculating the position of a target object on the three-dimensional coordinate space relative to the position of the head.

Several embodiments use the location, position, and size of target objects that are a certain body part, such as a head or eyes pointing towards a certain direction or a hand making a gesture or specific movements, to present a particular perspective of a scene on the display device. In various embodiments, if the system detects a head, face, or eyes, it then establishes a frustum, a three-dimensional shape which originates from the source of a user's point of view and encapsulates and contains their field of vision, providing the system with a calculated width of a field of view that shifts along with the user's movement, direction, and estimated point of view. This frustum provides a sense of depth and a basis for changing perspectives, rendering a particular perspective of a scene based on several factors that contribute to the frustum, including the position, viewing angle, and direction of the user or specific body parts, with the scene changing based on changes in the calculated frustum. When a user moves in three-dimensional space, the frustrum adjusts accordingly. A frustum may be of various geometric shapes.

In various embodiments, the field of view provided by the frustum is recalculated as the user moves or changes direction. After the system has detected and determined the target objects and has removed all other objects from image data, the system continuously captures updated position and distance data for the target objects and associated frustum and produces new perspectives, scenes, or images to be shown by the display device. In many embodiments, several display options are possible. For example, a user may move toward a display device or screen, and thereby cause a displayed object or scene to be expanded or magnified. Alternatively, the user may move away from a device or screen and cause objects or a scene to be reduced in size. As an image or video increases or decreases in size, the number of corresponding pixels used by each portion of a video, scene, or image also increases or decreases accordingly. In some embodiments, as a user moves from side to side, or laterally, the user may peak behind objects presented in a scene. For example, a user may view objects hidden behind a building that is displayed on the screen by peering around the virtual building, such as by getting close to or moving to one side of the display device.

One example of how a frustum may be utilized is that when a video is shown to a user, the video can be set to show and maintain one specific viewing angle or perspective to the user, such as a centered profile view, no matter how the user moves. As the user moves position or changes the direction of their gaze, the frustum adjusts, and the video perspective displayed on the screen shifts as well to maintain displaying the centered profile view to the user. In various embodiments, the frustum is used to show different perspectives to a user based on the position, direction, and field of view of the user as determined by the frustum. This means that a user may be presented with changing perspectives of a scene as the user moves laterally, diagonally, toward, away from, or any other way in 3-space in relation to the screen or display device.

In several embodiments a user interacts with the scenes displayed by the display device. The user may directly interact with virtual objects mapped on the positive z-axis coordinate space, where the positive z-axis represents physical space. Such interaction can be made using one or more objects the user is holding, or the user's hands or other designated body parts. Movement may occur when a user's hand grasps or touches an object, using a grasping gesture or object-defined stickiness. A release gesture may likewise be used to release the object. Virtual objects appearing in the positive z-axis may thus be translated from one position to another. In some embodiments, a user's hand changes the velocity of an object via collision dynamics.

Virtual objects mapped on the negative z-axis coordinate space, by their nature, can only be interacted with by indirect or projected interaction. Preferred embodiments implement projected interaction using a specialized 3D cursor designed for interaction in the virtual coordinate space. The display device presents virtual objects mapped on the physical space (positive z-axis coordinate space) differently to those mapped on the virtual space (negative z-axis coordinate space) to allow the user to differentiate between objects mapped in different spaces. For example, the 3D cursor may appear to be in a position proximate to the user, such as by hovering directly above a user's hand. An arrow cursor or gloved hand may be used to depict the 3D cursor on the display. A 3D surface may also be used to represent the cursor. In some embodiments, the cursor is affected by the user's position in the physical space, becoming larger as the user approaches the screen or smaller as the user moves away, or taking on lighting and shading characteristics of the physical space. Interactions with objects with a 3D cursor include but are not limited to selecting, rotating, enlarging, reducing, tapping, translating, moving, spinning, and throwing displayed objects.

Preferred embodiments define a first vector to implement the 3D cursor, such as a positional relationship between the user's elbow and hand. The first vector may project in a direction into the screen, through the virtual world, thereby defining a line of sight or series of line-of-sight positions in the 3D space. In these and further embodiments, object selection is made by placing the 3D cursor near, or centered over, an object in the 3D space. Gestures or commands, such as a single “tap”, are used to select the object. Subsequent clicks are used for further actions, such as listing tools or possible actions.

In some embodiments, the first vector originates from the position of the user's eye to the user's forefinger. Alternatively, the control vector originates directly from the user's forefinger, allowing the user to point naturally to control the cursor.

Further examples refer to use of a control vector from the user's forefinger into the virtual space. However, as discussed above, it should be understood that the user may employ a control device or smartphone in place of the forefinger, and that such exemplary embodiments are enabled in the same way as the examples that follow.

In preferred embodiments, to allow for natural pointing, the user's elbow position is determined. This determination is made based on the user's height and position in the physical space. Alternatively, point cloud data may be analyzed to determine the elbow position. A vector is then constructed from the elbow to the tip of the forefinger and points from the fingertip to the display screen.

The vector may further project into the virtual space. In some embodiments, a second vector is generated. the second vector originates from the point where the first vector intersects with the screen and follows a direction determined by the user's eye position. In generate the second vector points in the same direction as from the eye to the virtual space. However, in some embodiments, the second vector follows a different direction, such as to one item in a limited set of items. In some embodiments, the vector pointing into the virtual space is guided by a different pair of user control points, such as from the user's eye position to the user's forefinger.

It should be noted that by using a first vector from elbow to forefinger and a second vector in the virtual space, the second vector pointing in the direction from the eye to the forefinger, the user is better able to see the cursor as the cursor is guided by the user's finger. In embodiments in which a single vector from the eye to the forefinger is used to control the cursor, the cursor may be obscured from the user's view by the user's forefinger.

The use of two separately defined vectors ensures that the user's forefinger does not obscure the cursor from the user's view. Furthermore, the use of the second vector enables the user to track the virtual scene following a natural depth direction based on the head or eye position.

In some embodiments, methods of ensuring low latency and reduced noise are employed. Some embodiments include real-time updates to a virtual scene based on user interaction. In these embodiments, reduced latency and minimal noise are crucial to ensuring the optimal user experience.

For example, if finger position is measured using point cloud analysis, the finger may appear jittery—that is, the system may pick up small, fast movements of the user's finger. Such small, fast movements are generally natural when a user holds a finger in place, but it may be desirable to remove these movements from the measurements to ensure smooth movements of the cursor.

In preferred embodiments, the system reduces or eliminates the appearance of jitteriness by time-averaging the movement of the hand or finger. The time-averaging may be set to an interval determined by the amount of change, and rate of movement, of the user's hand or finger.

In some embodiments, the system uses speed sensitive position stabilization to reduce cursor jitter and latency. By way of background, depth sensor devices generate signal noise as a byproduct of data capture, transmission, and processing. Noise can affect the quality of the user's experience, producing jitter which would be visible in dependent display elements such as cursors. Traditional methods of noise reduction use temporal moving averaging or other filtering techniques that introduce latency or lag in overall responsiveness.

The exemplary embodiments address these issues by forming a dynamic tradeoff between jitter and visible latency based on current average velocity. At low velocities, where more jitter would be apparent, more filtering is applied, whereas at higher velocities, when less jitter would be apparent, less filtering is applied.

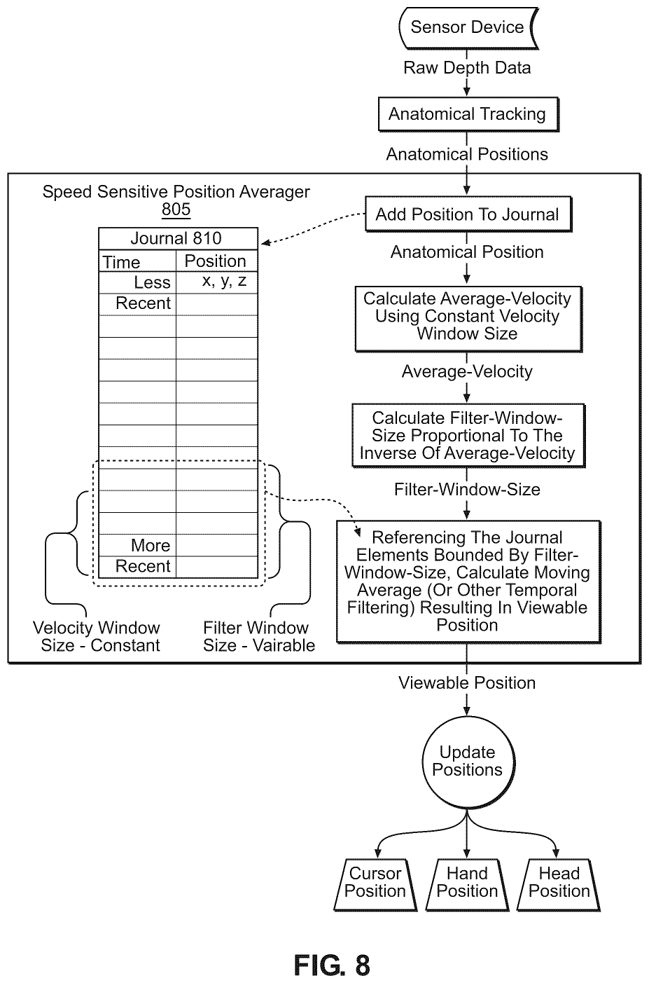

The sensor device receives raw depth data and anatomical positions by anatomical tracking. Other inputs are received where alternative modes for cursor input are used. The Speed Sensitive Position Averager uses a log, or journal, of one or more positions over time, as will be shown in FIG. 8 below. The average velocity of each anatomical position is calculated using constant velocity window size, which includes one or more entries within the journal. Filter window size is calculated as inversely proportional to average velocity. Referencing the journal elements bounded by filter window size, a moving average or other temporal filtering result is calculated, and a viewable position is displayed. The cursor position, hand position, and head position are subsequently updated.

Some embodiments deploy a physics engine to ensure that virtual objects move and react realistically to force and collisions. Traditional physics engines have objects overlap with each other before triggering a collision animation, which is a reactive and inefficient approach. In preferred embodiments, each object has mass, and a certain velocity when moving. The system therefore calculates the time until the next collision between objects. Based on that calculated time, the collision and its accompanying animation on the display device is executed, which in turn triggers another elapsed time calculation to collision between objects in a continuing cycle. One example is a collision between a user's hand and a virtual ball object. The user's hand, as a ‘target object’ is assigned an estimated mass value, and the ball is assigned a predetermined mass value. As the hand approaches the ball, calculations occur to estimate time elapsed until collision, and the animated collision occurs based on this time calculation.

Notably, objects do not need appear to be within reach. Objects that appear far away on the screen, such as an object shown on a distant horizon, are selectable by the cursor as though they were within the user's physical reach.

The following exemplary use cases are provided to illustrate methods of implementing and using the system described herein. The exemplary use cases outlined below are not exhaustive or exclusive and are provided for demonstrating some of the many ways in which the technology may be utilized.

In some embodiments, the technology may be used in shopping applications. For example, the virtual display may include merchandise such as a purse, watch, or car. In such embodiments, a user approaches the display and point toward the screen, activating a cursor. The virtual display is programmed to respond to user motions, such as rotation to the left or right, or up and down, with the user's hand motion. In this way, the user controls the roll, pitch, and yaw of an object in a virtual space.

Additionally, the user may direct the cursor, using a finger or control device, to an options menu. The options menu enables the user to see different options for the merchandise, such as different colors, styles, or features. In some embodiments, a zoom function is utilized to allow the user to zoom in and out, viewing the merchandise up close for texture and grain images, or viewing from far away for perspective.

Further, in some embodiments such as auto sales, the user is presented with the option to view inside a car. Upon selection, the virtual scene changes from the outside of the car to the inside, such as with a full panoramic image of the seating and console. The user again controls the perspective of the image, such as by pointing in a desired viewing direction. For example, the user may point to the right to shift the image to the right.

In some embodiments, the display menu includes a reset button. When a user has finished observing merchandise, or would like to start from the original perspective, the user guides the cursor to, and selects, the reset button. Alternatively, the virtual scene resets based on a timer that tracks the time interval over which no cursor activity is detected.

In further embodiments, the technology may be employed in gaming applications. Some such embodiments include virtual shooting games, in which virtual firearms are used. In some such embodiments, the forefinger represents the barrel of a virtual firearm and is directed at a virtual target. In some such embodiments, the trigger is actuated using a fast-motion gradient of the forefinger or, alternatively, by the pressing of a button on a virtual control or smart device application.

Gaming applications in some embodiments include sports in which the user's hands determine the position of a virtual racquet, club, or baseball bat. In such use cases, the physics engine determines the momentum and trajectory of objects in the game such as a tennis ball or baseball.

In further embodiments, the technology is employed for artistic purposes, such as virtual drawing or painting. The hands or control device act as a stylus for drawing on the screen or, alternatively, a surface in the virtual space.

Alternatively, in some embodiments, the technology is used to create an interactive virtual experience on a screen display, where a user plays a board game or pets an animal's head.

Regarding scene navigation, the following exemplary uses are provided. Again, these use cases are not exhaustive.

In some embodiments, the three-dimensional display shows an interactive scene featuring, for example, a forest. A user pointing in one particular direction, for example toward a particular tree, will cause the perspective to gradually shift such that the particular tree will become the center of the screen. Alternatively, in some embodiments, pointing to the left will cause the scene to shift to the left, while pointing to the right will cause the scene to shift to the right.

In some embodiments, the rate of change is also controlled. For example, in some embodiments, pointing to the far right will cause a rapid scene shift, while pointing slightly right of center will cause a gradual shift. The scene shift can be set to end at a certain far-right or far-left frame or may be configured for full 360-degree rotation.

Different modes of scene navigation in various embodiments are programmed for user interaction. In some embodiments, such modes include follow mode, where a user automatically follows a model as the model moves through a scene; track mode, in which a user automatically pivots from a fixed position to keep a model mid-frame as the model moves within the scene; rail mode, in which the user automatically moves along a line in the three-dimensional space to keep the model mid-frame within the scene; and tour mode, in which the user automatically moves and rotates along a path predefined by a sequence of waypoints. In tour mode, at various intervals, movement can pause or rotate to bring the user's attention to certain featured areas or objects within the scene.

In these and further embodiments, interactive navigation as enabled herein allows a user to “travel” inside a scene. Travel is performed by changing the location of the virtual window in response to user actions. The user's viewing position remains constant relative to the location of the virtual window.

In some embodiments, a “point to walk” mode is implemented. In “point to walk” mode, a user incrementally moves through a scene by pointing with their hand or finger, the movement taking the appearance of walking through the scene. Movement comprises aggregated rotation and aggregated forward displacement. In some embodiments, forward velocity is determined by the user's relative hand extension, whereby greater extension yields greater speed. Rotational velocity in some embodiments is determined by angles calculated by the user's pointing vector, whereby the greater the angle, the faster the rotational velocity.

Movement is constrained or modified in some embodiments based on the presence of obstructions in the scene. In such embodiments, obstructions represent object surfaces contained in the three-dimensional models. Examples include walls, trees, furniture, and similar objects. In some embodiments, obstructions are artificial, such as an invisible line or boundary that keeps the user within an intended area.

In some embodiments, movement triggers automatic behaviors based on current position. Examples include automatically climbing or descending a flight of stairs, automatically turning on lights, automatically opening a door, or automatically triggering an animation.

In some embodiments, a “point to fly” mode is implemented. In “point to fly” mode, a user incrementally moves through a scene, whereby the movement takes the appearance of flying through the scene. In some embodiments, a user may point up or down to navigate through the scene accordingly. In other embodiments, a user adjusts the forward velocity using relative extension of their hand, increasing apparent altitude when forward velocity reaches a configurable take-off speed, or decreasing apparent altitude by adjusting the arm extension to fall below the configurable take-off speed.

As noted previously, these and further embodiments of scene navigation may make use merely of the user's hand, or may use a joystick, steering wheel, gaming controller, or smart device. Modes of scene navigation may be pre-programmed or may be selectable by the user.

In some embodiments, the scene navigation systems and methods are implemented for touring a space virtually, such as real estate or tourist destinations. A person using the system may point at the screen to center a door or walkway on the screen, as described above. The system is configured for the user to gesture to walk down the walkway or through the door from one room to another. In some embodiments, a 360-degree panoramic camera captures an image of the entire room. One or more screens display the full panorama to give the user the illusion of standing in the center of the room with the ability to gesture-command to enter an adjoining room or proceed down a walkway.

While the present technology is susceptible of embodiment in many different forms, there is shown in the drawings and will herein be described in detail several specific embodiments with the understanding that the present disclosure is to be considered as an exemplification of the principles of the present technology and is not intended to limit the technology to the embodiments illustrated.

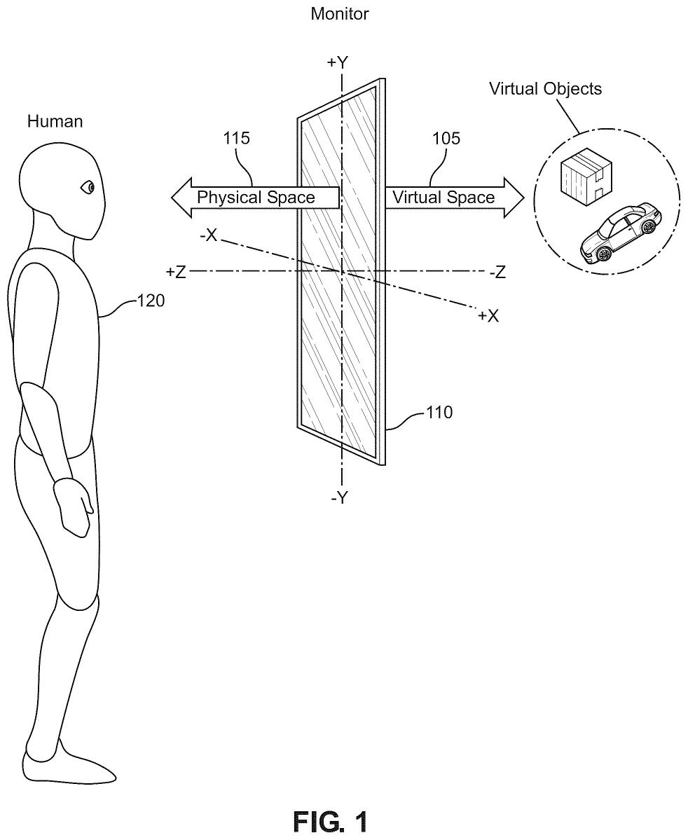

FIG. 1 diagrammatically illustrates an exemplary system and method for establishing, setting, and utilizing a three-dimensional coordinate space for object and scene interaction. The systems and methods establish, set, and utilize a three-dimensional coordinate space and map the space on top of physical space. In preferred embodiments, the positive and negative coordinate space of both the x-axis and y-axis of this three-dimensional space are set to exist solely within the surface boundary of the physical world or physical space 115 with virtual world or virtual space 105. The x-y plane thus represents the screen plane 110. The virtual space 105 can be rendered on a display device. In some embodiments, the z-axis is divided between the physical space 115 occupied by a user or observer 120 of the system and the virtual space 105 rendered on the display device. Generally, in such embodiments, the positive coordinates of the z-axis occupy physical space 115, and the negative coordinates of the z-axis occupy the virtual space 105 within the display device.

In FIG. 1 and the diagrams that follow, “mouse” is used to refer to a position on the screen-plane 110, generally on the monitor. “Mouse position” generally means the intersection of a pointing vector and the screen plane or x-y plane 110. In some embodiments, there is no visible representation of the “mouse”, while in some embodiments, the mouse is indicated with an arrow, hand, highlighted selection, or other depiction as outlined herein.

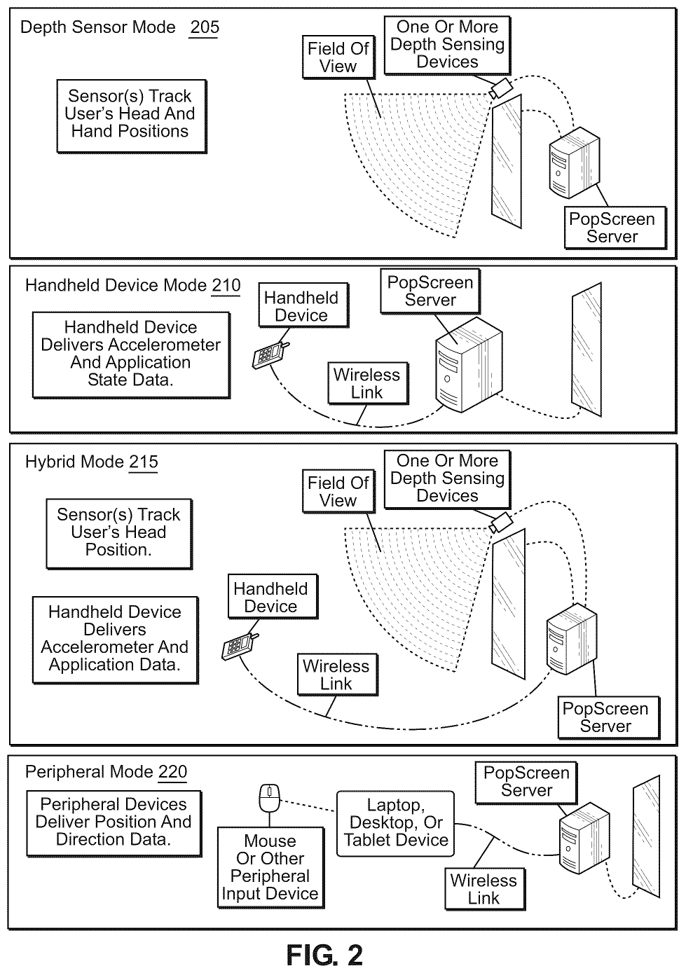

FIG. 2 diagrammatically illustrates an overview of four input modes for object and scene interaction. The four modes exemplified are Depth Sensor Mode 205, Handheld Device Mode 210, Hybrid Mode 215, and Peripheral Mode 220. In Depth Sensor Mode 205, one or more sensors track a user's head and hand positions as they are determined within the field of view. In Handheld Device Mode 210, a handheld device delivers accelerometer and application state data to a server. In preferred embodiments, a wireless link is used. In Hybrid Mode 215, one or more sensors track a user's head position, while a handheld device delivers accelerometer and application state data to the server, generally by a wireless link. In Peripheral Mode 220, peripheral devices such as a mouse deliver position and direction data. The mouse is connected to a personal computer, tablet, or other device, or alternatively is connected to the server by wireless link. Each mode will be shown in greater detail in subsequent figures.

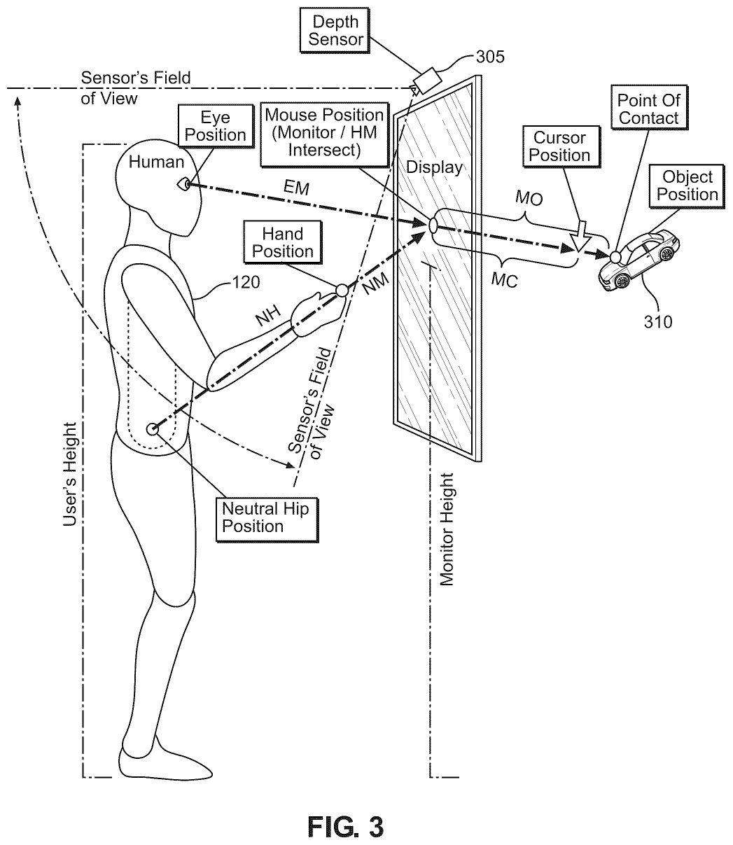

FIG. 3 diagrammatically illustrates the exemplary Depth Sensor Mode 205 in greater detail. In Depth Sensor Mode 205, one or more sensors 305 track a head of a user or observer 120 and hand positions as they are determined within a field of view. In some embodiments, the system determines the height of the user or observer 120 from point cloud data and evaluates an approximate eye position and an approximate hand position. Alternatively, the head and hand positions are determined from collected point cloud data, and height is determined subsequently. From the head and hand position data, the user's height can be determined, as well as the approximate eye position and neutral hip position.

From these various positions, the system establishes one or more vectors. In preferred embodiments, the one or more vectors include eye to mouse (EM), neutral hip to hand (NH), neutral hip to mouse (NM), mouse to cursor (MC), and mouse to object (MO). In some embodiments, the vectors EM, NH, and NM are used to guide the cursor on the display screen, while the vectors MC and MO guide the cursor in the virtual space 105 toward one or more virtual objects 310 within a virtual scene. For example, the closest virtual object 310 along the EM ray that yields a point of contact is highlighted for selection.

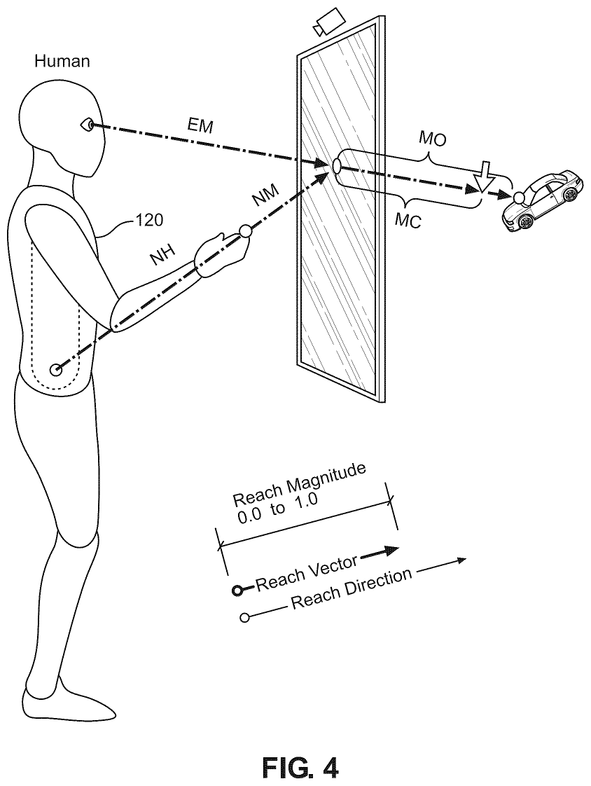

FIG. 4 diagrammatically illustrates an exemplary embodiment of a Reach Vector. In some embodiments, such as the embodiment shown in FIG. 4, the mouse to cursor (MC) vector is scalable by reach magnitude. Reach Magnitude is determined by mapping the length of the neutral hip to hand (NH) vector to predetermined values for minimum and maximum reach in the virtual space 105, yielding a scalar value in the range of 0.0 to 1.0. In exemplary embodiments, Reach Direction is determined by dividing the neutral hip to mouse (NM) vector by its magnitude to create a unit vector. The Reach Vector is the product of Reach Magnitude and Reach Direction.

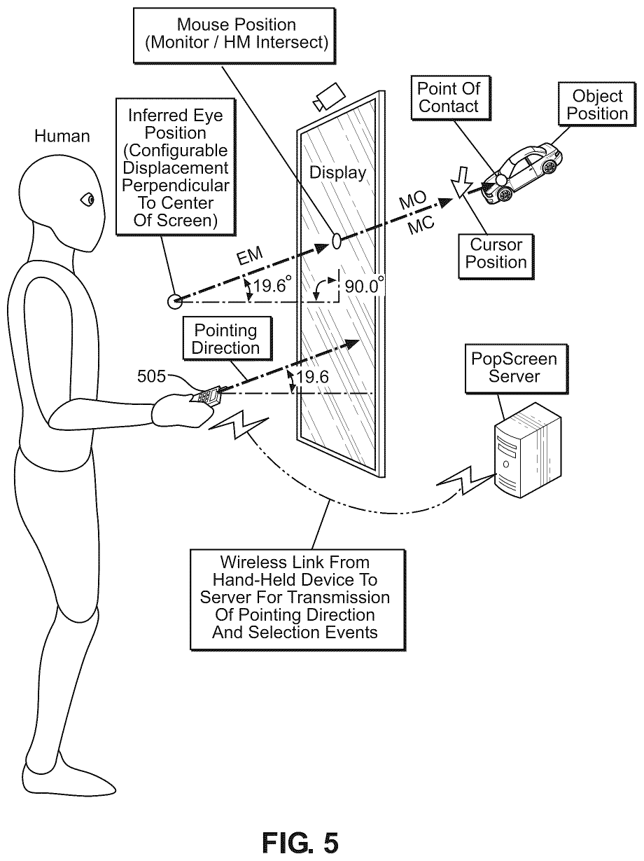

FIG. 5 diagrammatically illustrates an exemplary Handheld Mode 210. The system determines an inferred eye position. In some embodiments, inferred eye position is determined from configurable displacement of point cloud data perpendicular to the center of the screen. The handheld device 505 determines the pointing direction and click state of the mouse. An eye to mouse (EM) vector is determined in the physical space 115, and a mouse to cursor (MC) and mouse to object (MO) vector are calculated in the virtual space 105. The system determines the closest virtual object along the EM ray that yields a point of contact and determines a reach factor based on click status. The magnitude of the reach vector is based on handheld click status or, in some embodiments, application-specific methodology such as slider control included in a handheld application.

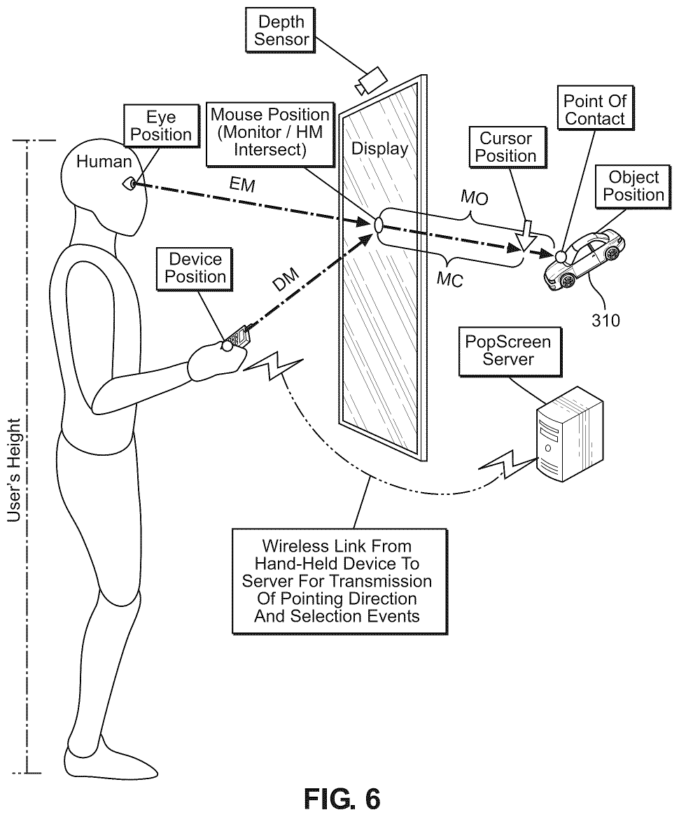

FIG. 6 diagrammatically illustrates an exemplary Hybrid Mode 215. As with Depth Sensor Mode 205, the system determines the height of the user or observer 120 from point cloud data and evaluates an approximate eye position and an approximate hand position, the hand position functioning as an approximate device position. Alternatively, the head and hand positions are determined from collected point cloud data, and height is determined subsequently. An eye to mouse (EM) vector and, in some embodiments, a device to mouse (DM) vector are established to direct the mouse position on the display screen. The device is generally a handheld device and may be a gaming or remote control or a smartphone, tablet, or other device. An EM ray follows the direction of the EM vector in the virtual space 105. As with the example in FIG. 3, in the example shown in FIG. 6, the closest virtual object 310 along the EM ray that yields a point of contact is highlighted for selection. In some embodiments, the handheld device transmits position and movement data directly, although in some embodiments, the depth sensor determines the position of the handheld device. In the virtual space, mouse to cursor (MC) and mouse to object (MO) vectors are established for directing the cursor to a point of contact on a virtual object within a virtual scene. In some embodiments, a Reach Vector is determined using the method outlined in FIG. 4 above.

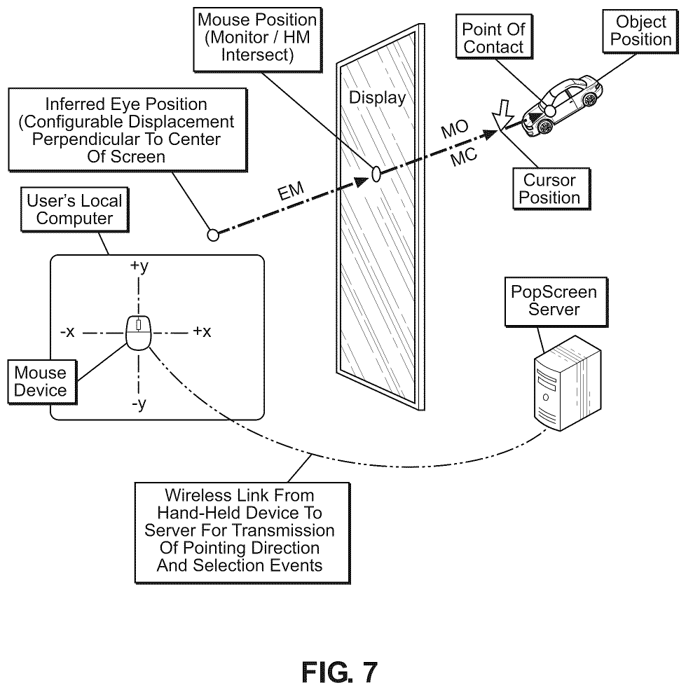

FIG. 7 diagrammatically illustrates an exemplary Peripheral Mode 220. In peripheral mode, an eye to mouse (EM) vector is calculated in the physical space 115 and the mouse to cursor (MC) and mouse to object (MO) vectors are calculated in the virtual space 105. As with Handheld Mode 210, the system determines an inferred eye position. In some embodiments, inferred eye position is determined from configurable displacement of point cloud data perpendicular to the center of the screen. A mouse or other cursor device is mapped onto the screen and the mouse position and click state are determined. The EM Vector and Ray are then calculated. As with Handheld Mode 210, the system determines the closest virtual object 310 along the EM ray that yields a point of contact and determines a reach factor based on click status. The magnitude of the reach vector is based on handheld click status or, in some embodiments, application-specific methodology such as slider control included in a handheld application. In some embodiments, a Reach Vector is determined using the method outlined in FIG. 4 above.

FIG. 8 diagrammatically illustrates an exemplary method for speed sensitive position stabilization. By way of background, depth sensor devices generate signal noise as a byproduct of data capture, transmission, and processing. Noise can affect the quality of the user's experience, producing jitter which would be visible in dependent display elements such as cursors. Traditional methods of noise reduction use temporal moving averaging or other filtering techniques that introduce latency or lag in overall responsiveness.

The exemplary method in FIG. 8 addresses these issues by forming a dynamic tradeoff between jitter and visible latency based on current average velocity. At low velocities, where more jitter would be apparent, more filtering is applied, whereas at higher velocities, when less jitter would be apparent, less filtering is applied.

According to the method exemplified in FIG. 8, the sensor device receives raw depth data and anatomical positions by anatomical tracking. Other inputs are received where alternative modes for cursor input are used. The Speed Sensitive Position Averager 805 uses a log, or journal 810, of one or more positions over time. The average velocity of each anatomical position is calculated using constant velocity window size, which includes one or more entries within the journal 810. Filter window size is calculated as inversely proportional to average velocity. Referencing the journal elements bounded by filter window size, a moving average or other temporal filtering result is calculated, and a viewable position is displayed. The cursor position, hand position, and head position are subsequently updated.

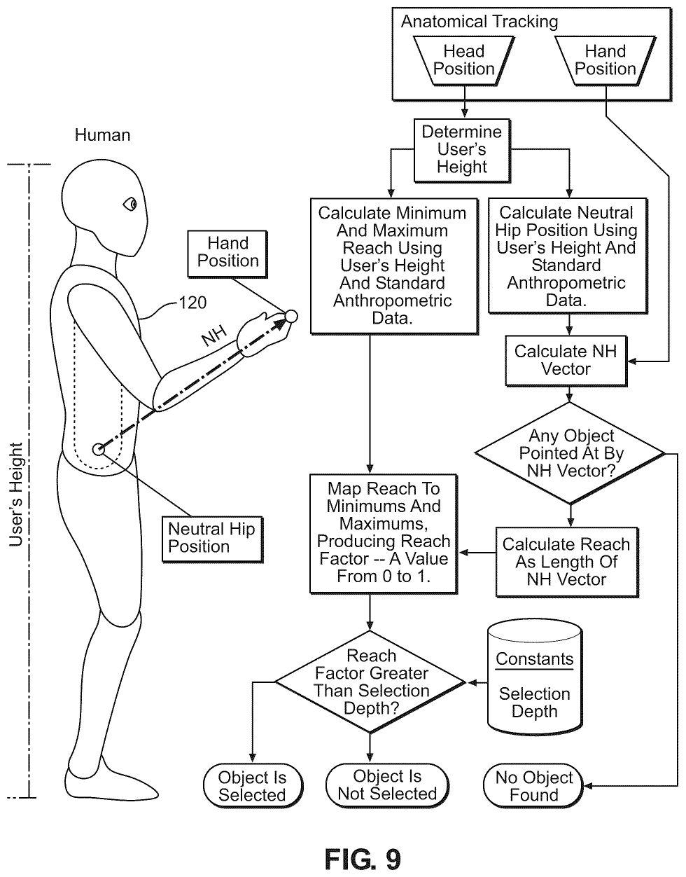

FIG. 9 diagrammatically illustrates an exemplary method for virtual object and scene selection. In the embodiment shown, anthropometric scaling is used to predict the length of the limbs of a user or observer 120. The scaling is performed by evaluating the height of the user or observer 120 against a standard human height and using the ratio to scale anatomical metrics, which are supplied by standard tables of human anthropometrics. From the resulting metrics, the user's head position, hand position, and neutral hip position are determined. In some embodiments, the height of the user or observer is determined from the head position, although in other embodiments, the height is determined separately using point cloud data. Subsequently, a minimum and maximum reach are determined from the height of the user or observer 120 and standard anthropometric data. In some embodiments, the neutral hip position is similarly calculated from user or observer 120 height and standard anthropometric data. From the hand position, as determined by anatomical tracking, a vector is established from the neutral hip to the hand (NH). If a virtual object is found along the NH vector, the system calculates the reach as the length of the NH vector, which exists between the minimum and maximum reach as previously determined. The virtual scene includes one or more constants for a selection depth. In some embodiments, if the reach factor is greater than the selection depth, the object is selected, whereas if the reach factor is less than the selection depth, no object is selected.

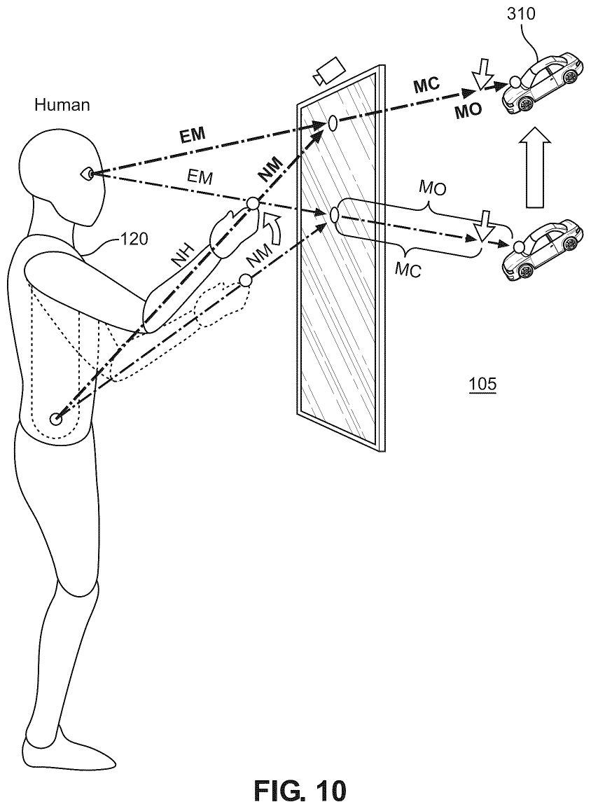

FIG. 10 diagrammatically illustrates an exemplary method for translation of objects in a virtual space 105. The user or observer 120 selects a virtual object 310 by pointing at the object and extending their reach. Once the object is selected, the user or observer 120 moves the object by pointing to another location. The user or observer 120 releases the object by retracting their hand, reducing their reach and consequently deselecting the virtual object 310.

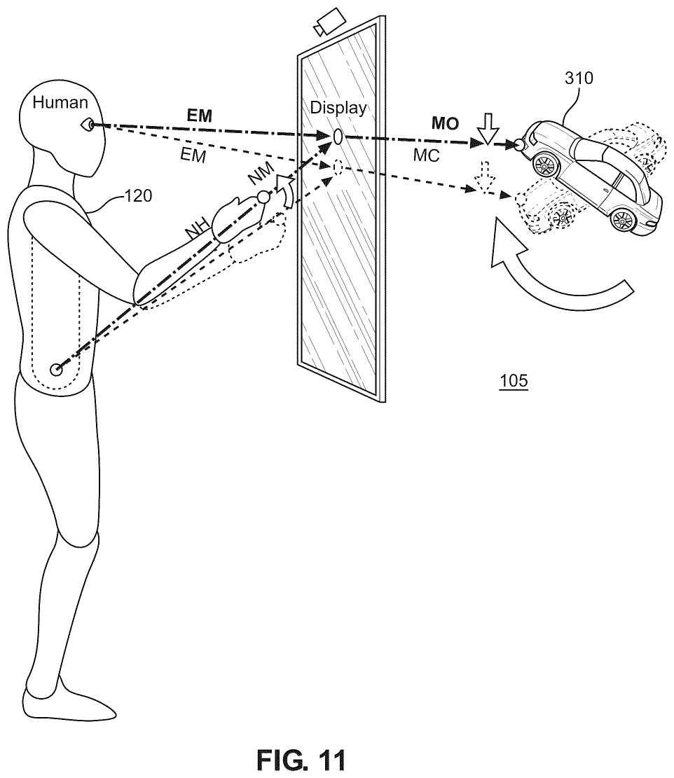

FIG. 11 diagrammatically illustrates an exemplary method for rotation of objects in a virtual space 105. The user selects an object by pointing at the object and extending their reach. Once the object is selected, the user rotates the object by pointing to another location. The user releases the object by retracting their hand, reducing their reach and consequently deselecting the object.

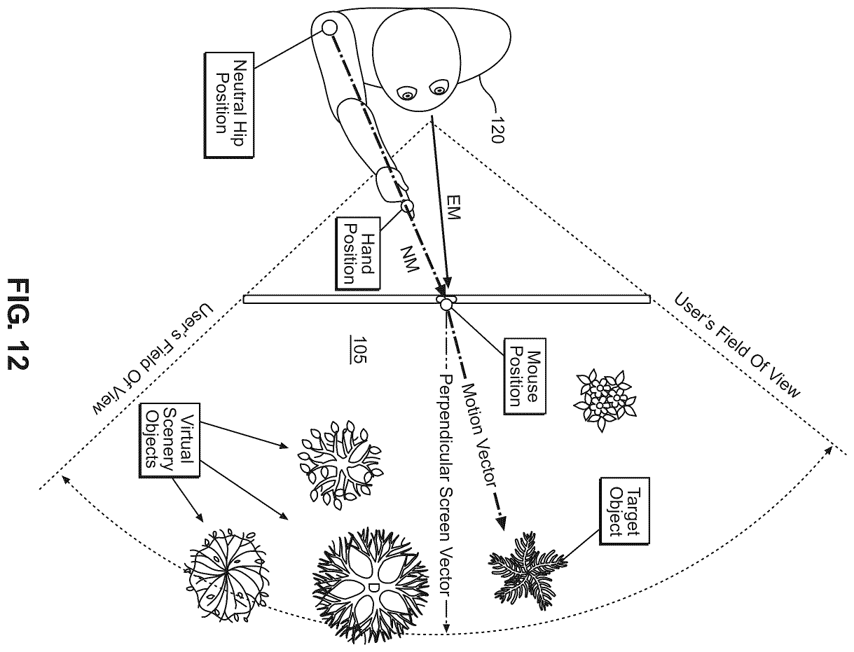

FIG. 12 diagrammatically illustrates an exemplary navigation motion vector for navigating through one or more scenes in a virtual space 105. The motion vector originates at the mouse position on the display screen and extends into the virtual space 105 in a direction parallel to the neutral hip to mouse (NM) vector. In preferred embodiments, the motion vector length is equal to that of the reach vector, although specific applications may call for an extended or shortened motion vector. Accordingly, the user follows the virtual scene in virtual space along a pre-determined path initiated by the navigation vector.

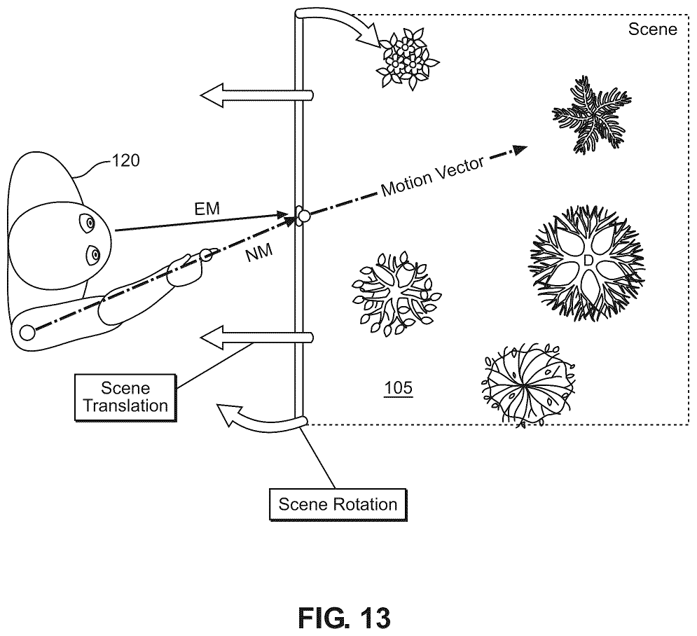

FIG. 13 diagrammatically illustrates applications of a motion vector in a virtual space 105. The user or observer 120 moves through a scene along the path determined by the motion vector. The movement comprises scene translation, in which the user or observer 120 appears to be moving along a perpendicular line into the scene (−Z direction), as well as scene rotation, where the scene is rotated about a center point, in this case located at the origin of the three-dimensional space.

In some embodiments, scene translation is determined using a translation factor. The translation factor is determined from a translation constant, which determines the actual rate of movement in the −Z direction, and a translation threshold, which sets the minimum motion magnitude necessary to begin the translation process. The motion magnitude is mapped to an intermediate value, and a linear or exponential function uses the intermediate value to determine the translation factor.

Additionally, in some embodiments, scene rotation is determined using a rotation factor. The rotation factor is determined from a rotation constant, which determines the actual rate of rotation around the scene's origin or a center point, and the rotation threshold, which determines the motion magnitude necessary to begin the rotation process. The motion magnitude is mapped to an intermediate value, and a linear or exponential function uses the intermediate value to calculate the rotational factor.

In some embodiments, the motion vector is used to determine the translation factor and rotation factor. Rotational rate is determined by multiplying the rotation factor by a preconfigured constant. Translation rate is determined by multiplying the translation factor by a preconfigured constant. At regular intervals, rates are multiplied by elapsed time, yielding incremental changes, or deltas, for translation and rotation. These changes result in the illusion of moving forward, turning, or moving forward and turning within a virtual scene 105.

It should be noted that in some embodiments, turning can be performed using a degree of motion magnitude that is greater than rotation threshold but less than that of the translation threshold. This gives the user the ability to rotate while remaining in place within the virtual scene.

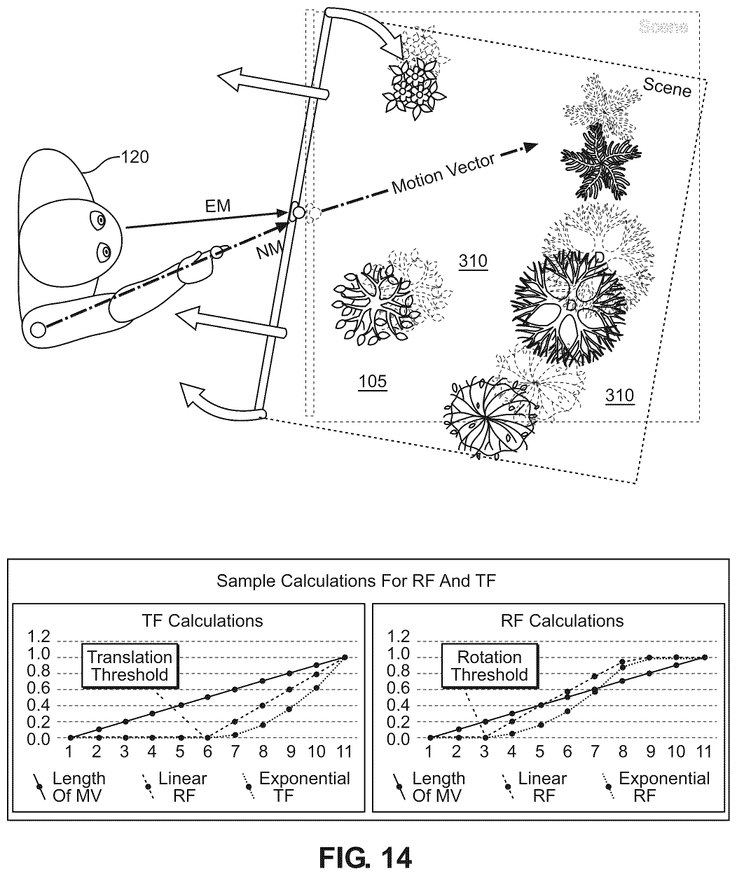

FIG. 14 further diagrammatically illustrates applications of the motion vector in a virtual space 105. In the example shown, the rotation threshold is less than the translation threshold. This enables the user or observer 120 to navigate a virtual scene near close virtual objects 310.

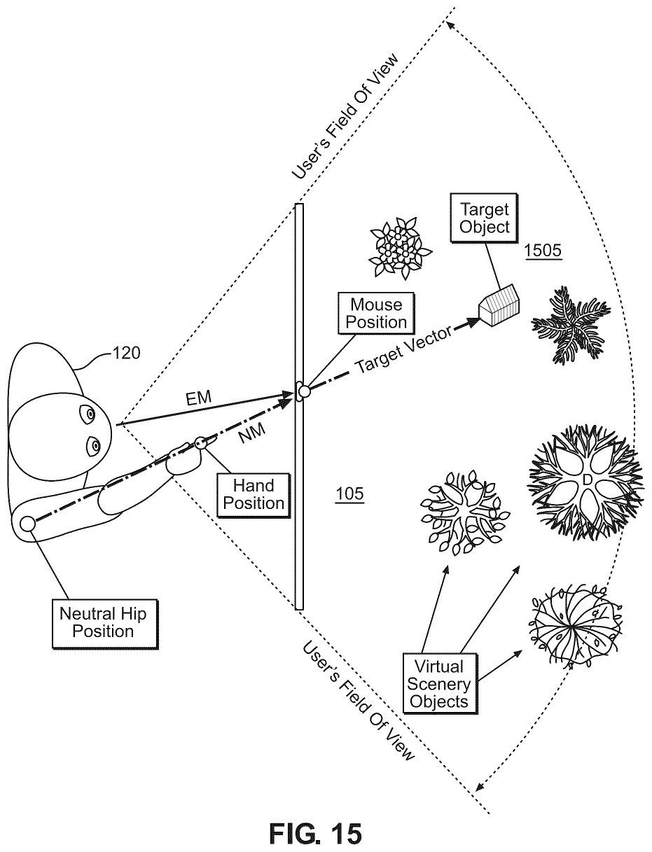

FIG. 15 diagrammatically illustrates an exemplary method of navigating a virtual scene 105 using targeted movement. In the embodiment shown, a target vector is established, originating from the mouse position on the display screen and projecting into the virtual space 105 in the direction parallel to a target object 1505. In some embodiments, target vector length is equal to the length of the reach vector, although specific applications may dictate that a varied length is used.

In some embodiments, when the reach vector's length exceeds a click depth, a click event is generated. Click events cause the scene to incrementally rotate and translate until the target object 1505 is located at the center position of the screen. In some embodiments, when the motion vector aligns with the target vector, the scene rotation, scene translation, or both are concluded.

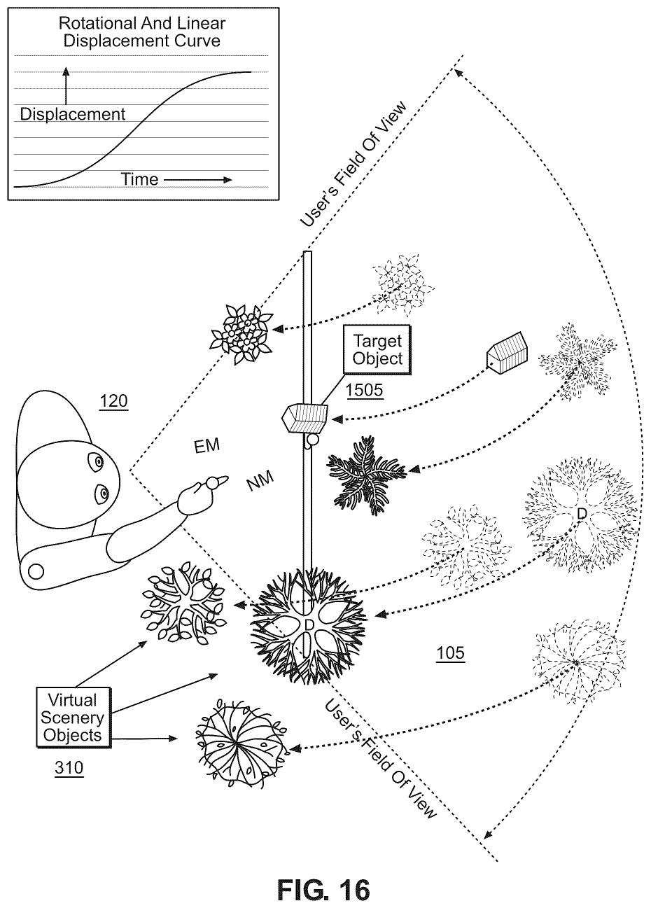

FIG. 16 further diagrammatically illustrates an exemplary method of navigating a virtual scene using targeted movement. As shown in FIG. 16, as a user or observer 120 points at a target object 1505, the scene is rotated about a center point (not shown) and translated along the −Z axis until the target object 1505 is in view and centered in the virtual scene. The scene uses an acceleration curve to imitate physical characteristics of movement.

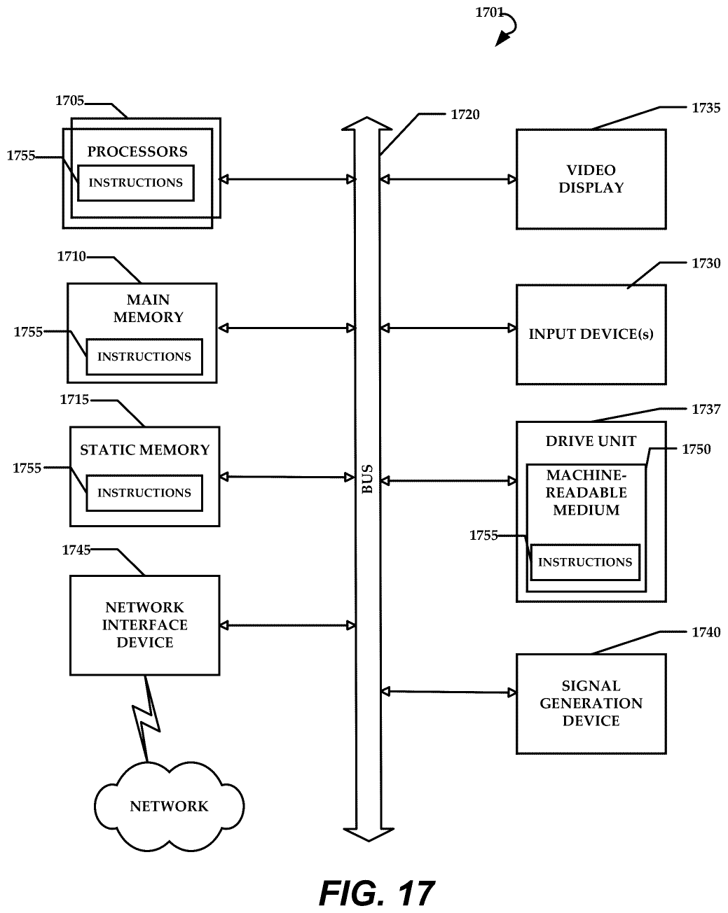

FIG. 17 is a diagrammatic representation of an example machine in the form of a computer system 1701, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1701 includes a processor or multiple processor(s) 1705 (e.g., a central processing unit (CPU), a graphics processing unit (GPU), or both), and a main memory 1710 and static memory 1715, which communicate with each other via a bus 1720. The computer system 1701 may further include a video display 1735 (e.g., a liquid crystal display (LCD)). The computer system 1701 may also include an alpha-numeric input device(s) 1730 (e.g., a keyboard), a cursor control device (e.g., a mouse), a voice recognition or biometric verification unit (not shown), a drive unit 1737 (also referred to as disk drive unit), a signal generation device 1740 (e.g., a speaker), and a network interface device 1745. The computer system 1701 may further include a data encryption module (not shown) to encrypt data.

The disk drive unit 1737 includes a computer or machine-readable medium 1750 on which is stored one or more sets of instructions and data structures (e.g., instructions 1755) embodying or utilizing any one or more of the methodologies or functions described herein. The instructions 1755 may also reside, completely or at least partially, within the main memory 1710 and/or within the processor(s) 1705 during execution thereof by the computer system 1701. The main memory 1710 and the processor(s) 1705 may also constitute machine-readable media.

The instructions 1755 may further be transmitted or received over a network via the network interface device 1745 utilizing any one of several well-known transfer protocols (e.g., Hyper Text Transfer Protocol (HTTP)). While the machine-readable medium 1750 is shown in an example embodiment to be a single medium, the term “computer-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the embodiments of the disclosure as described herein.

The computer program instructions may also be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel or may be performed at different times.

The various embodiments described above, are presented as examples only, and not as a limitation. The descriptions are not intended to limit the scope of the present technology to the forms set forth herein. To the contrary, the present descriptions are intended to cover such alternatives, modifications, and equivalents as may be included within the spirit and scope of the present technology as appreciated by one of ordinary skill in the art. Thus, the breadth and scope of a preferred embodiment should not be limited by any of the above-described exemplary embodiments.

What is claimed is:

1. A method for user interaction with a virtual scene, the method being executable by at least one processor communicatively coupled to at least one memory, the at least one memory storing one or more instructions for executing the method by the at least one processor, the method comprising:
receiving, by one or more sensory devices, point cloud data for a physical space, the point cloud data including a position of the user in the physical space;
extrapolating, from the point cloud data, a position of a head of the user, at least one neutral hip of the user, and at least one hand of the user;
determining, from the head position and hand position of the user, a height of the user;
establishing an eye to mouse vector directed through an eye position of the user to the screen, a neutral hip to hand vector, a neutral hip to screen vector, a mouse to cursor vector, and a mouse to virtual object vector;
guiding a mouse position on the screen of the display device by the eye to mouse vector, the neutral hip to hand vector, and the neutral hip to mouse vectors; and
guiding the mouse position in the virtual space by the mouse to cursor vector and the mouse to object vector.

2. The method of claim 1, further comprising generating a reach vector, the reach vector being the product of a reach direction and a reach magnitude, the reach magnitude being determined by mapping the length of the neutral hip to hand vector to predetermined values for a minimum and a maximum reach in the virtual space.

3. The method of claim 1, further comprising:
determining a closest virtual object that yields a line of contact along the eye to mouse vector; and
determining a click status of the mouse, the click state being determined by one of: an input from a handheld device, or by the user pointing to the virtual object and extending their arm reach in the direction of the virtual object.

4. The method of claim 1, further comprising selecting at least one object in the virtual space by:
calculating a minimum reach and a maximum reach in the virtual space from the height of the user and pre-determined anthropometric data;
determining a reach from the length of the neutral hip to hand vector;
mapping the reach to the minimum reach and the maximum reach to produce a reach factor; and
comparing the reach factor to a pre-determined selection depth, wherein if the reach factor is greater than the selection depth, the at least one virtual object is selected.

5. The method of claim 1, further comprising translating at least one object in the virtual space by the user selecting the object and moving their arm such that the neutral hip to mouse vector moves along the screen while the object is selected.

6. The method of claim 1, further comprising rotating the at least one virtual object in the virtual space by the user selecting the object and moving their arm such that the neutral hip to mouse vector rotates about one or more axes in the virtual space in the direction of the arm movement.

7. The method of claim 1, further comprising navigating a virtual scene by establishing a navigation vector that is parallel to the neutral hip to mouse vector, originates at the mouse position, and extends into the virtual space and following the virtual scene along a pre-determined path initiated by the navigation vector.

8. The method of claim 7, the navigating further comprising translating the virtual scene in a direction along the motion vector and rotating the virtual scene about a center point at the origin of the three-dimensional space.

9. The method of claim 7, further comprising concluding the navigation when the motion vector aligns with a target vector, the target vector pointing from the mouse position to a target object in the virtual space.

10. The method of claim 1, further comprising:
determining an inferred eye position from configurable displacement of cloud data perpendicular to the screen;
guiding a mouse position using a handheld device, the handheld device determining a pointing direction and a click state of the mouse.

11. A system for user interaction with a virtual scene, the system comprising:
one or more sensory input devices;
at least one processor communicatively coupled to the one or more sensory input devices; and
at least one memory communicatively coupled to the at least one memory, the at least one memory storing one or more instructions for executing the method by the at least one processor, the method comprising:
receiving, by one or more sensory devices, point cloud data for a physical space, the point cloud data including a position of the user in the physical space;
extrapolating, from the point cloud data, a position of a head of the user, at least one neutral hip of the user, and at least one hand of the user;
determining, from the head position and hand position of the user, a height of the user;
establishing an eye to mouse vector directed through an eye position of the user to the screen, a neutral hip to hand vector, a neutral hip to screen vector, a mouse to cursor vector, and a mouse to virtual object vector;
guiding a mouse position on the screen of the display device by the eye to mouse vector, the neutral hip to hand vector, and the neutral hip to mouse vectors; and
guiding the mouse position in the virtual space by the mouse to cursor vector and the mouse to object vector.

12. The system of claim 11, the method further comprising
tracking, by the one or more sensory devices, a head position and the at least one hand position of the user;
determining, from the head position and hand position of the user, a height of the user;
establishing an eye to mouse vector directed through an eye position of the user to the screen, a neutral hip to hand vector, a neutral hip to screen vector, a mouse to cursor vector, and a mouse to virtual object vector;
guiding a mouse position on the screen of the display device by the eye to mouse vector, the neutral hip to hand vector, and the neutral hip to mouse vectors; and
guiding the mouse position in the virtual space by the mouse to cursor vector and the mouse to object vector.

13. The system of claim 11, further comprising a reach vector, the reach vector being the product of a reach direction and a reach magnitude, the reach magnitude being determined by mapping the length of the neutral hip to hand vector to predetermined values for a minimum and a maximum reach in the virtual space.

14. The system of claim 11, the method further comprising:
determining a closest virtual object that yields a line of contact along the eye to mouse vector; and
determining a click status of the mouse, the click state being determined by one of: an input from a handheld device, or by the user pointing to the virtual object and extending their arm reach in the direction of the virtual object.

15. The system of claim 11, further comprising selecting at least one object in the virtual space by:
calculating a minimum reach and a maximum reach in the virtual space from the height of the user and pre-determined anthropometric data;
determining a reach from the length of the neutral hip to hand vector;
mapping the reach to the minimum reach and the maximum reach to produce a reach factor; and
comparing the reach factor to a pre-determined selection depth, wherein if the reach factor is greater than the selection depth, the at least one virtual object is selected.

16. The method of claim 11, further comprising translating at least one object in the virtual space by the user selecting the object and moving their arm such that the neutral hip to mouse vector moves along the screen while the object is selected.

17. The method of claim 11, further comprising rotating the at least one virtual object in the virtual space by the user selecting the object and moving their arm such that the neutral hip to mouse vector rotates about one or more axes in the virtual space in the direction of the arm movement.

18. The system of claim 11, the method further comprising:
determining an inferred eye position from configurable displacement of cloud data perpendicular to the screen;
guiding a mouse position using a handheld device, the handheld device determining a pointing direction and a click state of a mouse.

19. The system of claim 1, further comprising a handheld device determining a pointing direction and a click state of the mouse.

20. A non-transitory computer-readable storage medium having embodied thereon instructions which, when executed by a processor, perform the steps of a method for user interaction with a virtual scene, the method comprising:
receiving, by one or more sensory devices, point cloud data for a physical space, the point cloud data including a position of the user in the physical space;
extrapolating, from the point cloud data, a position of a head of the user, at least one neutral hip of the user, and at least one hand of the user;
determining, from the head position and hand position of the user, a height of the user;
establishing an eye to mouse vector directed through an eye position of the user to the screen, a neutral hip to hand vector, a neutral hip to screen vector, a mouse to cursor vector, and a mouse to virtual object vector;
guiding a mouse position on the screen of the display device by the eye to mouse vector, the neutral hip to hand vector, and the neutral hip to mouse vectors; and
guiding the mouse position in the virtual space by the mouse to cursor vector and the mouse to object vector.
